(19) United States
(12) Patent Application Publication
(10) Pub. No.: US 2022/0335446 A1
(43) Pub. Date: Oct. 20, 2022

(54) Real Food Honesty Display System

(71) Applicant: Sunshine Energy Technology Co., Ltd., Nantou City (TW)

(72) Inventor: Chin-Chan Hsieh, Nantou City (TW)

(21) Appl. No.: 17/230,079

(22) Filed: Apr. 14, 2021

(51) Int. Cl. G06Q 30/02; G06F 7/58

(52) U.S. Cl. CPC G06Q 30/0201; G06F 7/588; G06F 7/582

(57) ABSTRACT

A real food honesty display system contains: an electronic device, a record on spot device, and a field service device. The electronic device includes a processor configured to construct an independent random number and a pseudo random number which are updated based on a change of dynamic image of geographic information. The record on spot device includes a communicator. A field verification is executed by the record on spot device by using the geographic information, and a live transmission of a cultivation of an ecological structure of the dynamic image is executed. The field service device is configured to read the pseudo random number and includes a communication module built therein and connected with a hermetic package of the electronic device of the mesh network so that the independent random number and the pseudo random number are combined to the random number.

### FIELD OF THE INVENTION

The present invention relates to a system of recording farmer's production and sales history, and more particularly to a real food honesty display system which shoots video in accordance with actual production and sales process so as to record supply and demand and to provide consumers with more complete food security and safety.

### BACKGROUND OF THE INVENTION

The Internet of Things (IoT) is an information carrier (such as the Internet and traditional telecommunications networks). The security issue of resource data sharing and transmission between the Internet of Things, i.e., the data protection mechanism, is a very important issue of the Internet of Things. Therefore, for virtual digital currency, the block chain technology based on peer-to-peer networks has been gradually introduced into the field of Internet of Things in recent years.

The more common food-related management system, inclusive of ISO 22000 food safety management system, FSSC 22000 food safety system certification, SQF food safety quality standards, BRC British food safety standards, TQF Taiwan fine food . . . etc. Food safety issues have received more and more widespread attention. At present, the quality requirements of end customers can only enable practitioners in the food supply chain to more strictly control and check.

However, “strict control” and “strict gatekeeping” are not the same as “transparent certification, transparent breeding, and transparent growth of food ingredients”.

The present invention has arisen to mitigate and/or obviate the afore-described disadvantages.

### SUMMARY OF THE INVENTION

One aspect of the present invention is to provide a real food honesty display system which provides videos, photos, images of geographic information of a geographic information system shoot by a farmer so as to present product origin and manufacturing history to consumers, thus enhancing food safety and brand image.

Secondary aspect of the present invention is to provide a real food honesty display system which is capable of providing a food safety solution that combines nature certification, friendly farming, fresh food purchases, global transparent central kitchens, and IoT records.

Further aspect of the present invention is to provide a real food honesty display system which applies truth to guide discernment and judgment so as to allow many things to be cut and to look for higher consumer trust.

Another aspect of the present invention is to provide a real food honesty display system which is capable of providing insect certification and animal certification, because the biological chain constructed by the biological nature of the place of origin is actually friendly planting, and the happy and friendly breeding of animals is guaranteed by the animals themselves.

Another aspect of the present invention is to provide a real food honesty display system by which a farmer voluntarily creates an environment that conforms to the diversity of organisms, and allows these organisms to take himself/herself every day to pass safe planting land.

Another aspect of the present invention is to provide a real food honesty display system which is capable of providing the record of pictures to convey the farmer's trust and true feelings about the ingredients to consumers, to obtain the information of the needs. Preferably, the diversity and realism achieves trust and allows many consumers to go to the farmland and build trust with the farmer relationship.

To obtain the above aspects, a real food honesty display system provided by the present invention contains: an electronic device, a record on spot device, and a field service device.

The electronic device includes a processor configured to construct an independent random number and a pseudo random number, and the independent random number and the pseudo random number are connected with a mesh network. The independent random number and the pseudo random number are updated based on a change of dynamic image of a geographic information, the independent random number and the pseudo random number are combined to a random number, and the independent random number, the pseudo random number, the geographic information and the dynamic image are transformed into a hermetic package by using an elastic function, then the hermetic package is saved. When the hermetic package has a read access, the electronic device acquires one of insect image features or animal image features of the dynamic image of the geographic information, such that at least one increasing or reducing numerical response of an insect image or an animal image is constructed based on the insect image features or the animal image features of the dynamic image so as to acquire one of audio characters of emotional expression from the dynamic image, and the audio characters are preset in multiple emotional dimension databases and correspond to an affect reciprocity of Animalia so as to confirm the one audio character of the multiple emotional dimension databases is a positive emotion or a negative emotion, such that an environmental health value is produced according to an increasing quantity, a shrinking quantity, or the affect reciprocity of the Animalia.

The record on spot device includes a communicator connected with the mesh network so as to download the independent random number. A field verification is executed by the record on spot device by using the geographic information, a live transmission of a cultivation of an ecological structure of the dynamic image is executed, and the geographic information and the dynamic image are combined with the independent random number so as to upload the geographic information, the dynamic image, and the independent random number to the mesh network.

The field service device is configured to read the pseudo random number, and the field service device includes a communication module built therein and connected with the hermetic package of the electronic device of the mesh network so that the independent random number and the pseudo random number are combined to the set close to the random number, such that the geographic information and the dynamic image of the hermetic package are read, and a numerical response is captured from the dynamic image of the geographic information of the record on spot device so as to reflect the numerical response becomes better or worse with the time. The dynamic image are the insect image or the animal image, alternatively, the affect reciprocity of the Animalia is captured from the dynamic image of the record on spot device so as to determine the positive emotions or the negative emotions increase or decrease, thus distinguishing product quality in the ecological structure, wherein the affect reciprocity is the positive emotion or the negative emotion.

### BRIEF DESCRIPTION OF THE DRAWINGS

FIG. 1 is a diagram showing a real food honesty display system according to a first embodiment of the present invention.

FIG. 2 is a flow chart of mesh network architecture of the real food honesty display system according to the first embodiment of the present invention.

FIG. 3 is a diagram showing a table of random numbers inclusive of independent random numbers and pseudo random numbers of FIG. 1 according to the first embodiment of the present invention.

FIG. 4 is a diagram showing the operation of a record on spot device of the real food honesty display system according to the first embodiment of the present invention.

FIG. 5 is a diagram showing the operation of the real food honesty display system according to the first embodiment of the present invention.

FIG. 6 is another diagram showing the operation of the real food honesty display system according to the first embodiment of the present invention.

FIG. 7 is also another diagram showing the operation of a field service device the real food honesty display system according to the first embodiment of the present invention.

FIG. 8 is a diagram showing the operation of an electronic device of the real food honesty display system according to the first embodiment of the present invention.

FIG. 9 is another diagram showing the operation of the electronic device of the real food honesty display system according to the first embodiment of the present invention.

FIG. 10 is a diagram showing a table of random numbers of FIGS. 1 and 2 inclusive of independent random numbers and pseudo random numbers according to the first embodiment of the present invention.

FIG. 11 is a diagram showing a table of random numbers of FIGS. 8 and 9 inclusive of independent random numbers and pseudo random numbers according to the first embodiment of the present invention.

FIG. 12 is a diagram showing the application of the real food honesty display system according to the first embodiment of the present invention.

FIG. 13 is a flow chart showing the operation of the electronic device of the real food honesty display system according to the first embodiment of the present invention.

FIG. 14 is another flow chart showing the operation of the electronic device of the real food honesty display system according to the first embodiment of the present invention.

FIG. 15 is a flow chart showing the operation of a record on spot device of the real food honesty display system according to the first embodiment of the present invention.

FIG. 16 is a flow chart showing the operation of a block chain network of the real food honesty display system according to the first embodiment of the present invention.

FIG. 17 is a flow chart showing the operation of the independent random numbers and the pseudo random numbers of the real food honesty display system according to the first embodiment of the present invention.

FIG. 18 is another flow chart showing the operation of the field service device of the real food honesty display system according to the first embodiment of the present invention.

### DETAILED DESCRIPTION OF THE PREFERRED EMBODIMENTS

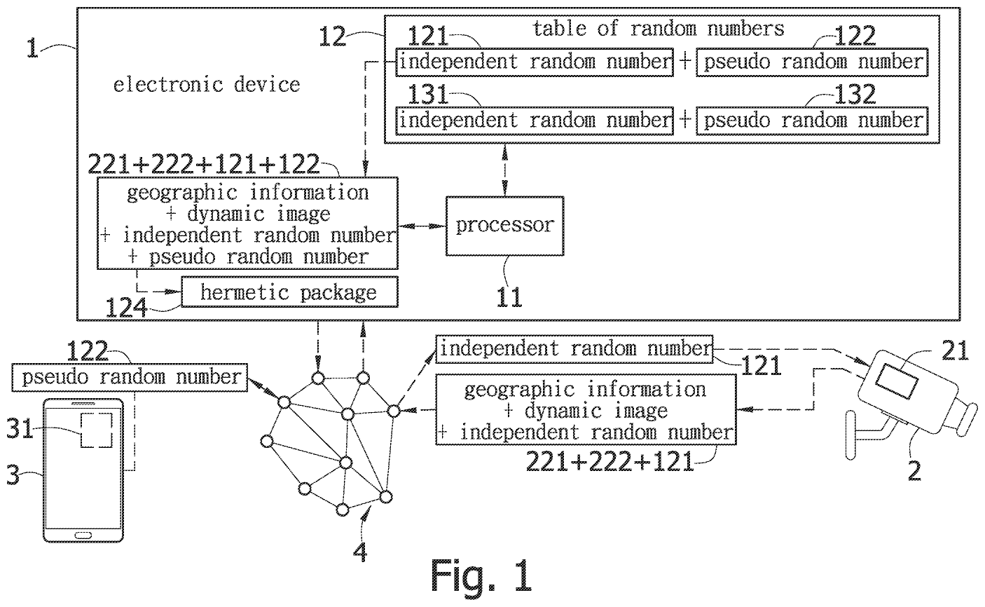

With reference to FIG. 1, a real food honesty display system according to a first embodiment of the present invention comprises: an electronic device 1, a record on spot device 2, and a field service device 3.

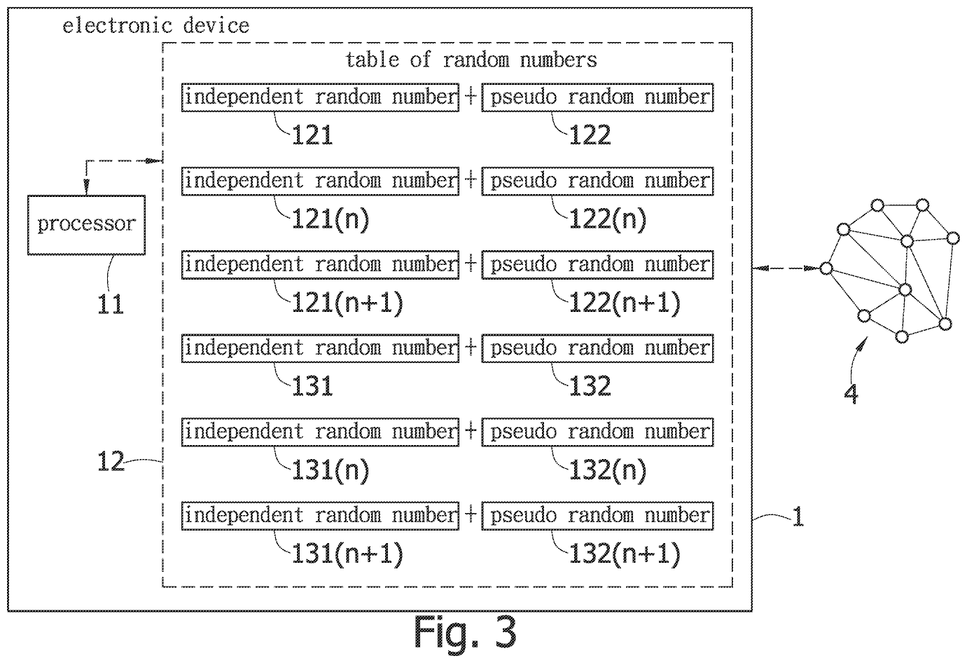

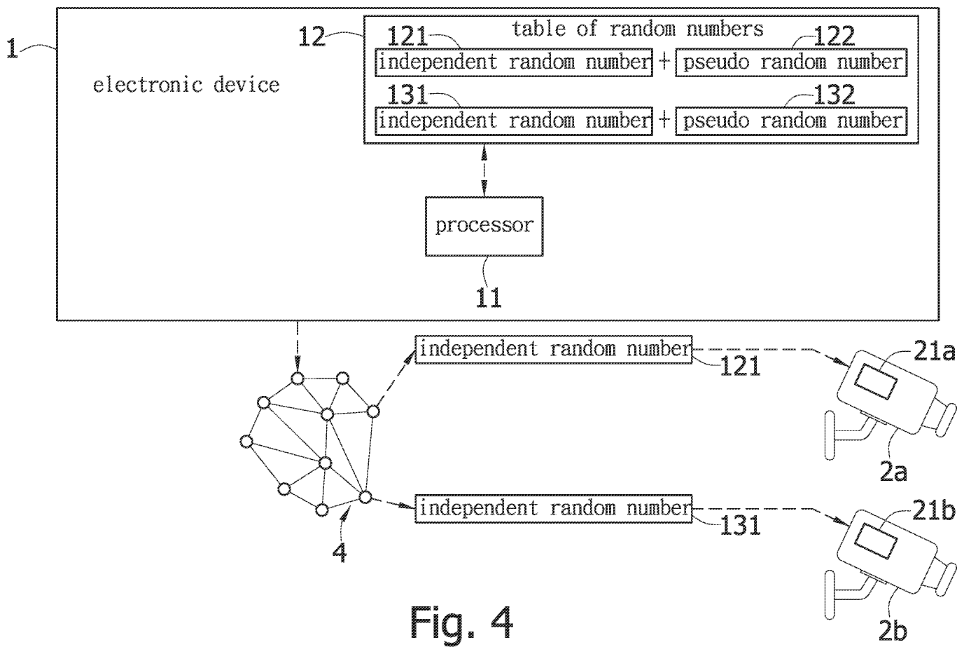

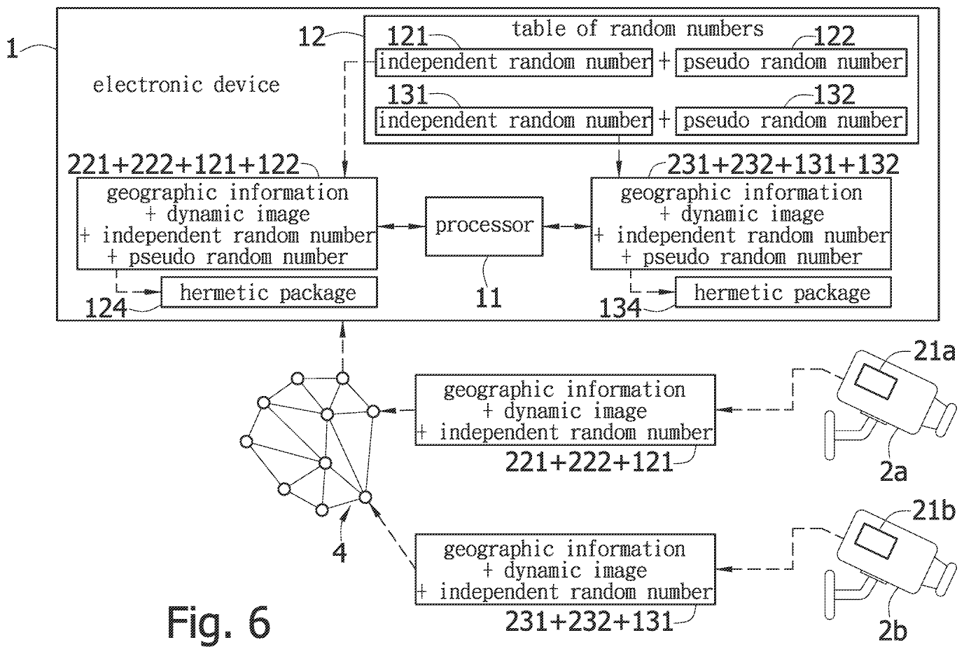

Referring to FIGS. 3 and 4, the electronic device 1 includes a processor 11 having an independent random number 121 and a pseudo random number 122 by which a table of random numbers 12 is formed, and the table of random numbers 12 is connected with a mesh network 4 or a block chain network 5, wherein the independent random number 121 and the pseudo random number 122 are updated based on dynamic image 222 of a geographic information 221, for example, the independent random number 121 is updated to n+1, and the pseudo random number 122 is updated to n+1. As shown in FIG. 6, the independent random number 121 and the pseudo random number 122 are combined to a random number, and the independent random number 121, the pseudo random number 122, the geographic information 221 and the dynamic image 222 are transformed into a hermetic package 124 (i.e. true binary random bits, such as 1 or 0) by using an elastic function, then the hermetic package 124 is saved, wherein when the hermetic package 124 has a read access, the electronic device 1 acquires one of insect image features or animal image features from Animalia of the dynamic image 222 of the geographic information 221 of the record on spot device 2, such that an environmental health impact assessment module is guided based on the one insect image feature or the animal image features so as to produce at least one increasing or reducing numerical response (such as an increasing quantity, a shrinking quantity, a fixed quantity, or a unknown quantity). Thereafter, audio characters (such as frequency, rhythm, volume change, intensity change, etc., corresponding to an affect reciprocity of the Animalia) of an emotional expression are acquired from the dynamic image 222 so as to further acquire one of the audio characters which is preset in multiple emotional dimension databases and corresponds to the affect reciprocity of the Animalia and to confirm the one audio character of the multiple emotional dimension databases is a positive emotion or a negative emotion, such that an environmental health value is produced according to the increasing quantity, the shrinking quantity, or the affect reciprocity of the Animalia, wherein the environmental health value of ecological structure or the affect reciprocity of the Animalia becomes better or worse with time, an increasingly using quantity of pesticides, no pesticides. For example, the environmental health value of the ecological structure or the affect reciprocity of the Animalia becomes worse with the increasingly using quantity of the pesticides. The environmental health value of the ecological structure or the affect reciprocity of the Animalia becomes better with no pesticides. The Animalia is comprised of multiple types of insects, multiple insect groups, multiple types of animals, and multiple animal groups.

Furthermore, the audio characters of the insects or the animals reflect emotion, reaction or feeling of the ecological structure of the Animalia by way of different colors, geometry changes, image changes, speed changes, different rhythms (such as rotating, nodding, beating, etc.) and are displayed by flat images or stereoscopic images. For instance, in one ecological structure, a farm is cultivated on site with a pesticide-free natural agricultural method, wherein when the audio characters of the multiple types of insects or the multiple types of animals corresponding to multiple audio character of a respective insect or a respective animal are produced by using the record on spot device 2, the audio characters are sent to the electronic device 1 so as to produce the dynamic image 222 of the multiple types of insects or the multiple types of animals on the field service device 3 having a display, wherein the multiple types of insects or the multiple types of animals are displayed in the dynamic image 222. Alternatively, the dynamic image 222 (of the multiple insects or the multiple animals) corresponding to situation, emotion, rhythm, or intensity of the ecological structure) are produced from the Animalia, for example, the more insects or animals are, the higher intensity or the stronger brightness of the image is.

As illustrated in FIG. 4, the record on spot device 2 includes a communicator 21 connected with the mesh network 4 (or the block chain network 5) so as to download the independent random number 121, wherein the record on spot device 2 is positioned by the geographic information 221 of a geographic information system (GIS) or global positioning information of a global positioning system (GPS), wherein a field verification and a live transmission of at least one planter are executed by using the global positioning information of the GPS and the geographic information 221 of the GIS so as to confirm whether cultivation of the ecological structure of the dynamic image 222 is executed by ways of a natural agriculture, wherein the geographic information 221 and the dynamic image 222 are combined to produce the independent random number 121, and the independent random number 121 is uploaded to the mesh network 4 or the block chain network 5. The dynamic image 222 at least includes live action(s) of audio character of the Animalia (such as a real estate of increasingly or decreasingly quantitative character of the multiple insects or the multiple animals), a real estate of an increasingly or decreasingly positive emotion or negative emotion of the Animalia, or a real estate of an increasingly or decreasingly negative emotion or negative emotion of the Animalia.

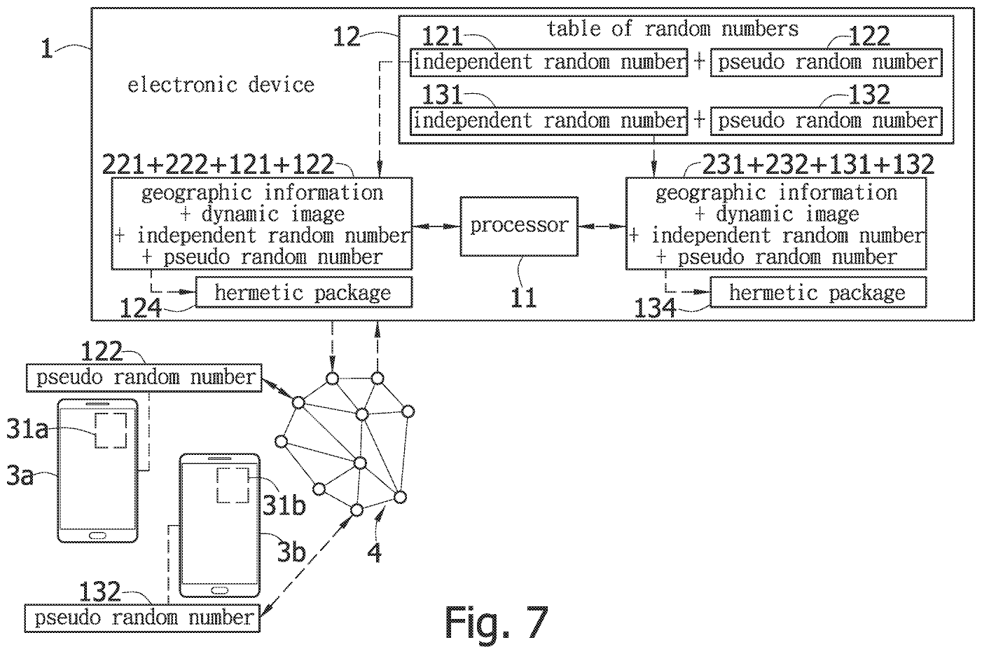

With reference to FIG. 7, the field service device 3 having a display is configured to read the pseudo random number 122, and the field service device 3 includes a communication module 31 built therein and connected with the hermetic package 124 of the electronic device 1 of the mesh network 4 (or the block chain network 5) so that the independent random number 121 and the pseudo random number 122 are combined to the set close to the random number, such that the geographic information 221 and the dynamic image 222 of the hermetic package 124 are read, and a numerical response is captured from the dynamic image 222 (such as insect image or an animal image) of the geographic information 221 of the record on spot device 2 so as to reflect the numerical response becomes better or worse with the time. Alternatively, the affect reciprocity (such as the positive emotion or the negative emotion) of the Animalia is captured from the dynamic image 222 of the record on spot device 2 so as to determine the positive emotions or the negative emotions increase or decrease, thus distinguishing product quality in the ecological structure.

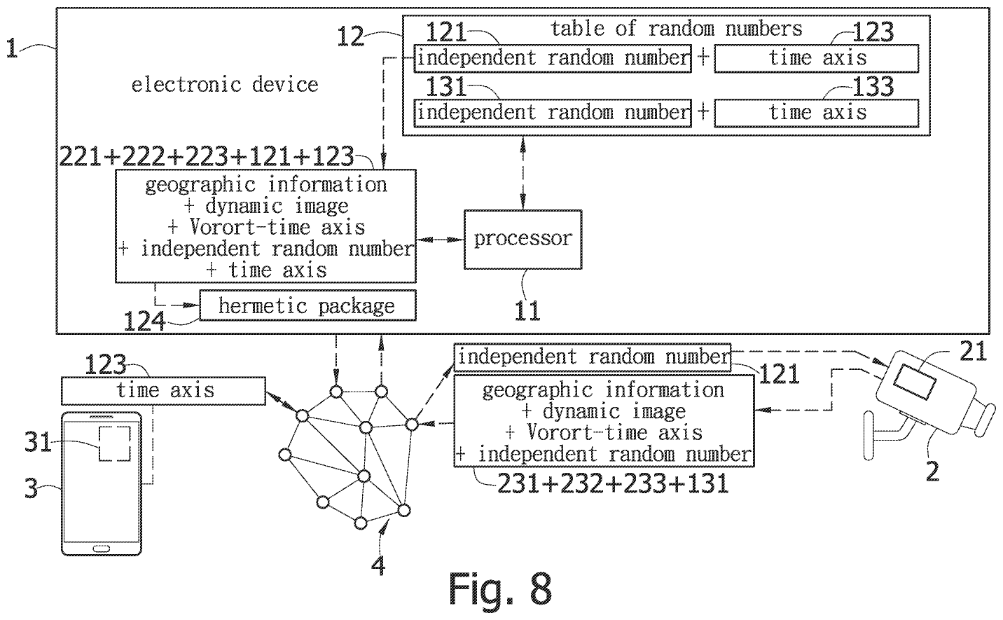

With reference to FIG. 8, a real food honesty display system according to a second embodiment of the present invention comprises: an electronic device 1, a record on spot device 2, and a field service device 3.

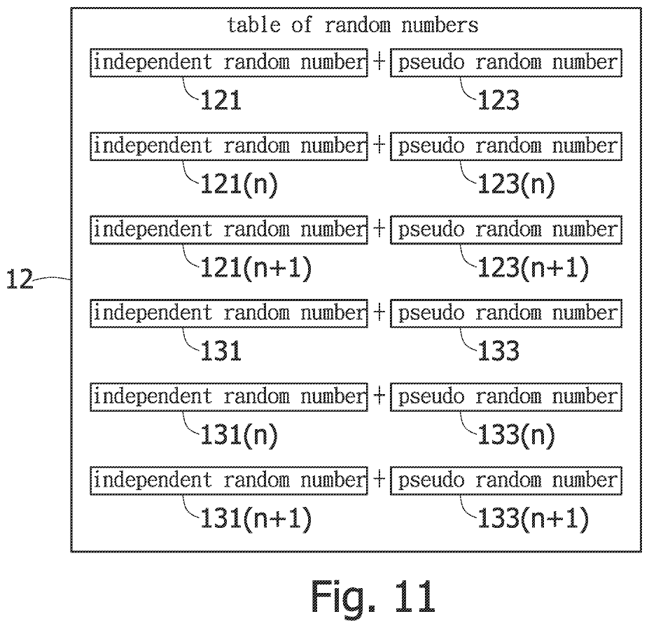

Referring to FIGS. 8 and 11, the electronic device 1 includes a processor 11 having an independent random number 121 and a time axis 123 by which a table of random numbers 12 is formed, and the table of random numbers 12 is connected with a mesh network 4 or a block chain network 5, wherein the independent random number 121 and the time axis 123 are updated based on a geographic information 221 and a dynamic image 222 of a spot time axis 223, for example, the independent random number 121 is updated to n+1, and the time axis 123 is updated to n+1. The independent random number 121 and the time axis 123 are combined to a random number, and the independent random number 121, the time axis 123, the geographic information 221 and the dynamic image 222 are transformed into a hermetic package 124 (i.e. true binary random bits, such as 1 or 0) by using an elastic function, then the hermetic package 124 is saved, wherein when the hermetic package 124 has a read access, the electronic device 1 acquires one of insect image features or animal image features from Animalia of dynamic image 222 of the geographic information 221 and the spot time axis 223 of the record on spot device 2, such that an environmental health impact assessment module is guided based on the one of the insect image features or the animal image features so as to produce at least one increasing or reducing numerical response (such as an increasing quantity, a shrinking quantity, a fixed quantity, or a unknown quantity). Thereafter, audio characters of an emotional expression are acquired from the dynamic image 222 so as to further acquire one of audio characters which is preset in multiple emotional dimension databases and corresponds to the affect reciprocity of the Animalia and to confirm the one audio character of the multiple emotional dimension databases is a positive emotion or a negative emotion, such that an environmental health value is produced according to the increasing quantity, the shrinking quantity, or the affect reciprocity of the Animalia, wherein the environmental health value of ecological structure or the affect reciprocity of the Animalia becomes better or worse with time, an increasingly using quantity of pesticides, no pesticides. For example, the environmental health value of the ecological structure or the affect reciprocity of the Animalia becomes worse with the increasingly using quantity of the pesticides. The environmental health value of the ecological structure or the affect reciprocity of the Animalia becomes better with no pesticides. The increasing quantity or the fixed quantity of the Animalia occurs with no pesticides so that the environmental health value of the ecological structure becomes better. The shrinking quantity or the unknown quantity of the Animalia occurs when increasing pesticide and the environmental health value of the ecological structure becomes worse. The Animalia is comprised of multiple types of insects, multiple insect groups, multiple types of animals, and multiple animal groups.

The electronic device 1 acquires audio characters of at least one emotional expression of the Animalia from the dynamic image 222 of the record on spot device 2 so as to further acquire one of audio characters which is preset in multiple emotional dimension databases and corresponds to the affect reciprocity of the Animalia and to confirm positive emotions of the audio characters of the multiple emotional dimension databases increase or decrease or to confirm negative emotions of the audio characters of the multiple emotional dimension databases increase or decrease, such that the affect reciprocity of the Animalia of the ecological structure acquired from the record on spot device 2 becomes better or worse with time. In addition, the environmental health value or the affect reciprocity of the Animalia becomes worse when increasing the pesticides. The environmental health value or the affect reciprocity of the Animalia becomes better when decreasing the pesticides or not using the pesticides. For example, when the affect reciprocity of the Animalia is well-being or excitation, the environmental health value becomes better. When the affect reciprocity of the Animalia is panic, aggressive or hopelessness, the environmental health value becomes worse.

In this embodiment, sound records of different terrestrial animals (such as cats, dogs, cows, sheep and horses) are collected. In a first step, the different terrestrial animals are classified in a systematic zoology, such as morphology, classification, evolution and economic significance. In a second step, a sound level is used to identify emotional analysis of the animals and to have acoustic analysis of recorded sounds of the terrestrial animals, such that an emotion display rule of the audio characters of the terrestrial animals is understood by way of sound frequencies, and the positive emotion or the negative emotion is distinguished by using the emotion display rule, wherein the positive emotion of the Animalia is well-being or excitation, and the negative emotion of the Animalia is panic, aggressive or hopelessness.

The audio characters of the at least one emotional expression of the Animalia are acquired from the dynamic image 222 of the record on spot device 2 so as to further acquire one of audio characters of an emotional expression. For instance, when the affect reciprocity of the Animalia is the well-being or the excitation of the positive emotion, the environmental health value becomes better or the pesticides are used decreasingly. When the affect reciprocity of the Animalia is panic, aggressiveness or hopelessness of the negative emotion, the environmental health value becomes worse or the pesticides are used increasingly.

The record on spot device 2 includes a communicator 21 connected with the mesh network 4 (or the block chain network 5) so as to download the independent random number 121, wherein the record on spot device 2 is positioned by the geographic information 221 of a geographic information system (GIS) or global positioning information of a global positioning system (GPS), wherein a field verification and a live transmission of at least one planter are executed by using the global positioning information of the GPS, the geographic information 221 of the GIS, and the spot time axis 223 of the record on spot device 2 so as to confirm whether cultivation of the ecological structure of the dynamic image 222 is executed by ways of a natural agriculture, wherein the geographic information 221, the dynamic image 222, and the spot time axis 223 are combined to produce the independent random number 121, and the independent random number 121 is uploaded to the mesh network 4 or the block chain network 5. The dynamic image 222 at least includes live action(s) of audio character of the Animalia (such as a real estate of increasingly or decreasingly quantitative character of the multiple insects or the multiple animals), a real estate of an increasingly or decreasingly positive emotion or negative emotion of the Animalia, or a real estate of an increasingly or decreasingly negative emotion or negative emotion of the Animalia.

The field service device 3 having a display is configured to read the time axis 123, and the field service device 3 includes a communication module 31 built therein and connected with the hermetic package 124 of the electronic device 1 of the mesh network 4 (or the block chain network 5) so that the time axis 123 and the independent random number 121 are combined to the set close to the random number, such that the time axis 123 and the dynamic image 222 of the hermetic package 124 are read, and a numerical response is captured from the geographic information 221 and the spot time axis 223 of the dynamic image 222 of the record on spot device 2 so as to reflect the numerical response of the Animalia becomes better or worse with the time. Alternatively, a affect reciprocity (such as the positive emotion or the negative emotion) of the Animalia is captured from the dynamic image 222 of the record on spot device 2 so as to determine the positive emotions or the negative emotions increase or decrease, thus distinguishing product quality in the ecological structure.

The electronic device 1 combines the audio characters of the insects or the animals or the affect reciprocity of the dynamic image 222 by using an elastic function so as to avoid an error.

For instance, in the dynamic image 222, some animals guide desired results. The elastic function is configured to protect the real estate of the Animalia of the dynamic image 222. In this embodiment, the multiple types of insects, the multiple insect groups of the Animalia and three to five dynamic image 222 of a continuous time are selected, and a first type of insects, a second type of insect . . . a n^{th} type of insect or a n^{th}+1 type insect are selected, then the first type of insects are divided into three groups and multiple insects of the first type of insects are selected etc. until at least one insect (i.e. the first type of insects) of the dynamic image 222 is obtained, wherein the dynamic image 222 recorded by the record on spot device 2 display the at least one insect (i.e. the first type of insects) are the real estate of the audio characters or the affect reciprocity of the insect or the animal, such that the electronic device 1 tolerates blind spots of the dynamic image 222, and the errors are eliminated when the dynamic image 222 produce.

The elastic function is selected from a majority of the Animalia, for example, the multiple types and groups of animals and three to five dynamic image 222 of the continuous time are selected, and a first type of animals, a second type of animal . . . a n^{th} type of animal or a n^{th}+1 type of animal are selected, then the first type of animals are divided into three groups and multiple animals of the first type of animals are selected etc. until at least one animal (i.e. the first type of animals) of the dynamic image 222 is obtained, wherein the dynamic image 222 recorded by the record on spot device 2 display the at least one animal (i.e. the first type of animals) are the real estate of the audio characters or the affect reciprocity of the insect or the animal, such that the electronic device 1 tolerates blind spots of the dynamic image 222, and the errors are eliminated when the dynamic image 222 produce.

The electronic device 1 has an internet access function, such as a smart phone, a person digital assistant (PDA), a desktop computer, a laptop or a tabular computer. In this embodiment, the electronic device 1 includes the processor 11, a network system, a storage medium, and an input/output (I/O) device. The processor 11 is at least electrically coupled to the network system, the storage medium, and the I/O device.

The network system supports wireless signal transmission of at least one of following systems: a global system for mobile communication (GSM), a fourth generation communications system, and a fifth generation mobile network, a long term evolution (LTE) network, a wireless fidelity (Wi-Fi) system, a worldwide interoperability for microwave access system, a mesh network 4, and a block chain network 5.

The independent random number 121 of the electronic device 1 is unpredictable so as to avoid producing two identical sequences of the independent random number 121. The independent random number 121 produces when receiving the dynamic image 222 randomly, for example, receiving a change of one dynamic images 222 so as to update the independent random number 121, thus forming an updated independent random number 121 (n+1). A sequence of the independent random number 121 is generated by an independent random number 121 generator. It is the natural random characteristic and true random source of the autogeny phenomenon of the positive emotion or the negative emotion that relies on the affect reciprocity of the insect or the animal in a nature. For the independent random number 121 generator, there is no initial sequence or initial number, which is capable of eliminating a period problem of pseudo-randomness and is difficult to find solution.

The pseudo random number 122 of the electronic device 1 is produced after being calculated by mathematical formulas of a pseudo random number 122 generator. It starts from an initial state and uses a certain algorithm to generate the pseudo random number 122. Once the algorithm and seed are given, an output sequence is determined and has a certain periodicity. The sequence of the pseudo random number 122 has relatively good random statistical characteristics, is generated by a mathematical algorithm, and is close to a true random sequence in some statistical characteristics, but the sequence of the pseudo random number 122 is periodic and predictable. The pseudo random number 122 is easy to obtain and convenient to use, and it is generally applicable for simulation, commerce, and sales.

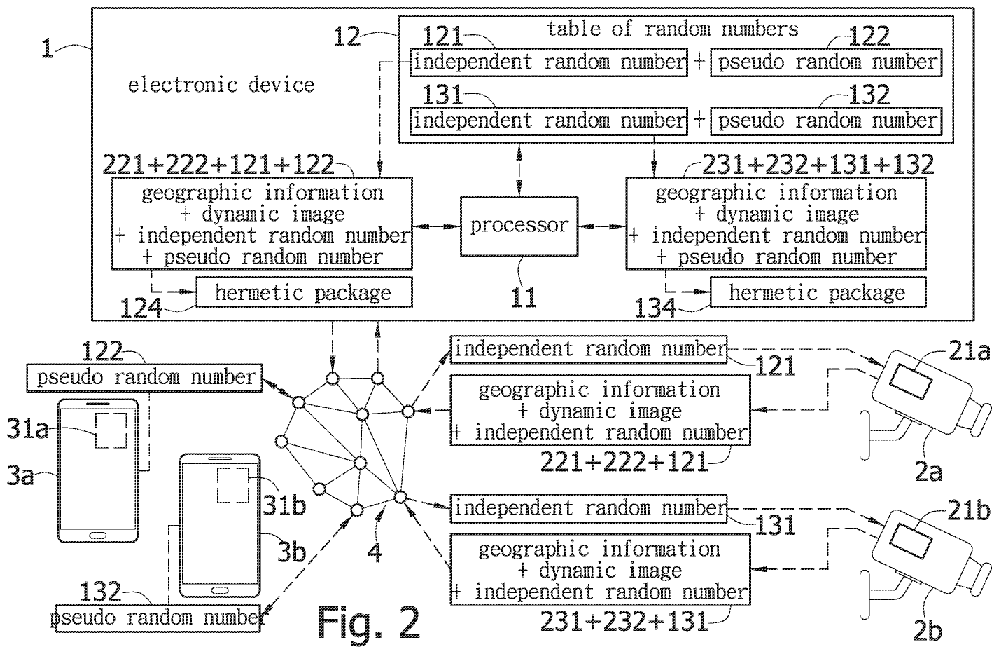

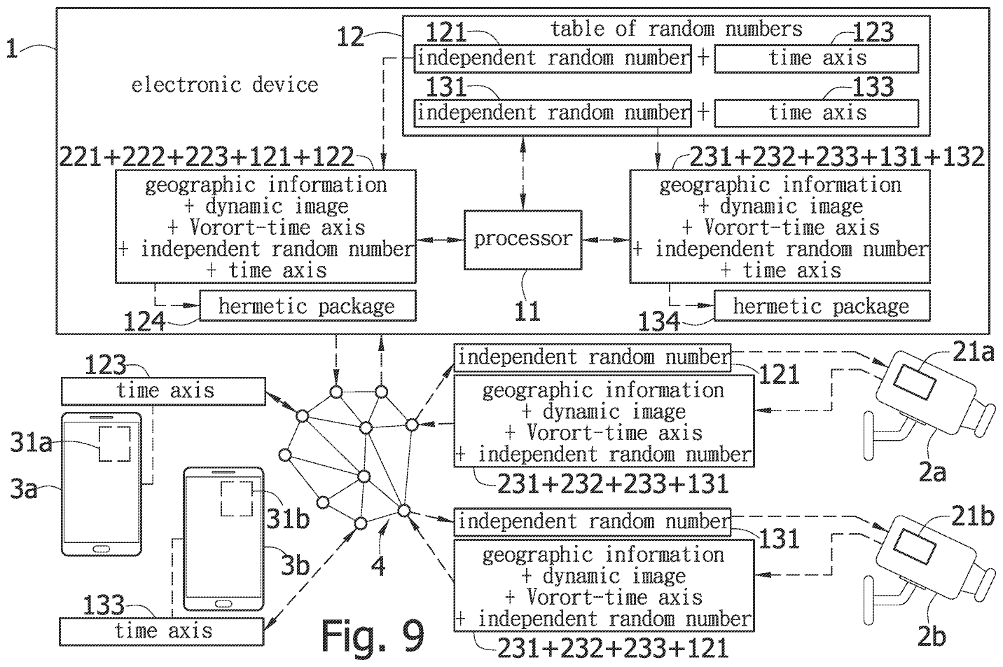

Referring to FIGS. 2 and 9, the mesh network 4 includes the electronic device 1, two record on spot devices 2a, 2b, and two field service devices 3a, 3b. Related elements, characters, and functions of the two record on spot devices 2a, 2b and the two field service devices 3a, 3b are similar those of the electronic device 1. In this embodiment, the mesh network 4 has a proximity-based network architecture with three-level hierarchical architecture.

FIG. 2 is a flowchart of a method for sharing the dynamic images 222 and 232 on the mesh network 4 according to the present invention, wherein the dynamic images 222, 232 are used in multiple scenarios. The electronic device 1 is a root node and a group owner of the mesh network 4 so as to share the dynamic images 222, 232 and to generate two independent random numbers 121, 131 and two pseudo random numbers 122, 132 (or two time axes 123, 133 of FIG. 9).

The two record on spot devices 2a, 2b are a first layer child node of the electronic device 1. A first farmer A uses the record on spot device 2a as the first layer child node of the electronic device 1 and downloads the independent random number 121, and a second farmer B uses the record on spot device 2b as the first layer child node of the electronic device 1 and downloads the independent random number 131. The electronic device 1 automatically sends the two independent random numbers 121, 131 to the two record on spot devices 2a, 2b and authorizes or stops the two record on spot devices 2a, 2b being provided into the mesh network 4. The two record on spot devices 2a, 2b are a smart phone or a tablet computer configured to shoot at least one video, at least one image, at least one continuous image, at least one digital image, or at least one photo, at least one picture, or at least one still picture. The geographic informations 221, 231 of a geographic information system are configured to position and represent GPS data of the GPS or global positioning data of a GPS, and the geographic informations 221, 231 of the geographic information system are used for positioning so as to verify the ecological structure cultivated by the farmer (planter) himself by way of the at least one image or the at least one picture shoot by the farmer (planter). Thereby, each consumer watches whether the farmer (planter) cultivates the ecological structure by using the natural agriculture and the geographic informations 221, 231 and the dynamic images 222, 232 combine the independent random numbers 121, 131 and are uploaded to the mesh network 4.

Accordingly, place of origin and manufacturing process of the product (such as food) are displayed by the dynamic images 222, 232 so that consumers learn these information. Preferably, the dynamic images 222, 232 present biological chains of the ecological structure (such as a farm), the positive emotion or the negative emotion of the affect reciprocity of the Animalia (such as the insects or the animals) so as to obtain friendly planting purpose and to enhancing food safety and brand image.

The dynamic image or video are captured by the farmer by using the smart phone or the tablet computer, and the dynamic image are sent to the processor 11 of the electronic device 1 via the mesh network 4, wherein the dynamic image are edge detected by the processor 11 so as to acquire binary images learned by the processor 11, and moving insects or animals are detected and captured by way of a motion detection algorithm, the moving insects or animals are combined by a block multiplexer and are eliminated shadows by using a shadow merge, thus obtaining quantitative characters of the insects and the animals in the nature.

The framer A downloads the independent random number 121 from the root node of the electronic device 1 by using the first layer child node of the record on spot device 2a at a first location, and the geographic information 221 and the dynamic image 222 of the first location are combined as the independent random number 121 and uploaded to the root node or the electronic device 1.

The framer B downloads the independent random number 131 from the root node of the electronic device 1 by using the first layer child node of the record on spot device 2b at a second location, and the geographic information 231 and the dynamic image 232 of the second location are combined as the independent random number 131 and uploaded to the root node or the electronic device 1.

The two field service devices 3a, 3b are the second layer child node and the two pseudo random numbers 122, 132 (or the two time axes 123, 133 of FIG. 9) of the electronic device 1. The two field service devices 3a, 3b are the smart phone or the tablet computer of a consumer, a store, a dealer, a spreader, a value trader, and a market maker. Then, the consumer, the store, the dealer, the spreader, the value trader, and the market maker read a bar code symbol or a barcode data or a bar-coded label formed from the two pseudo random numbers 122, 132 (or the two time axes 123, 133 of FIG. 9) by way of a camera of the smart phone or the tablet computer, and the bar code symbol, the barcode data and the bar-coded label are connected to two hermetic packages 124, 134 of the electronic device 1 of the mesh network 4 via two communication modules 31a, 31b.

With reference to FIG. 7, a consumer C reads the pseudo random number 122 at the store of a third location (or a n^{th} location or a n+1^{th} location) by using of the camera of the field service device 3a (such as the smart phone or the tablet computer) after linking with the hermetic package 124 of the electronic device 1 of the mesh network 4, such that the dynamic image 222 of the hermetic package 124 is read so as to capture an insect quantity recorded by the record on spot device 2a at the first location, such that an increasing or decreasing of an insect structure, an insect morphology, an insect ecology, or a colonial insect is obtained. For example, insects belong to the class of insects in taxonomy, regardless of type or quantity; they are the largest in the Animalia. Taking the insect for an example, a development process of a type of insect undergoes a series of changes, called metamorphosis depending on a degree of metamorphosis, it is classified as: complete metamorphosis, incomplete metamorphosis, and ametabolic. The life history of the insect is divided into egg stage, juvenile stage, (pupa stage), and adult stage. The complete metamorphic insect has a pupa stage, while the incomplete metamorphosis and ametabolic insect do not have the pupa stage. The quantitative character of the insects includes butterfly having complete metamorphic, wherein when the butterfly was young, it was a caterpillar; when the butterfly grows up, it pupates and finally emerges as the butterfly with beautiful wings. The quantitative character of the insects also includes a structure of imago, such as a head, chest, and an abdomen, a growing history and a life history when the insect has appendage. For instance, the head of the insect has antennae, and its chest has three pairs of feet and two pairs of wings.

When a consumer D reads the pseudo random number 132 at the store of a fourth location (or a n^{th} location or a n+1^{th} location) by using of the camera of the field service device 3b (such as the smart phone or the tablet computer) after linking with the hermetic package 134 of the electronic device 1 of the mesh network 4, the dynamic images 222, 232 of the hermetic package 134 are read so as to capture an insect quantity recorded by the record on spot device 2b at the second location, such that an increasing or decreasing of the insect structure, the insect morphology, the insect ecology, or the colonial insect is obtained.

The electronic device 1 is configured to detect whether the record on spot devices 2a, 2b, the field service devices 3a, 3b are not connected with the mesh network 4. The electronic device 1 manages above-mentioned process by way of the table of random numbers 12.

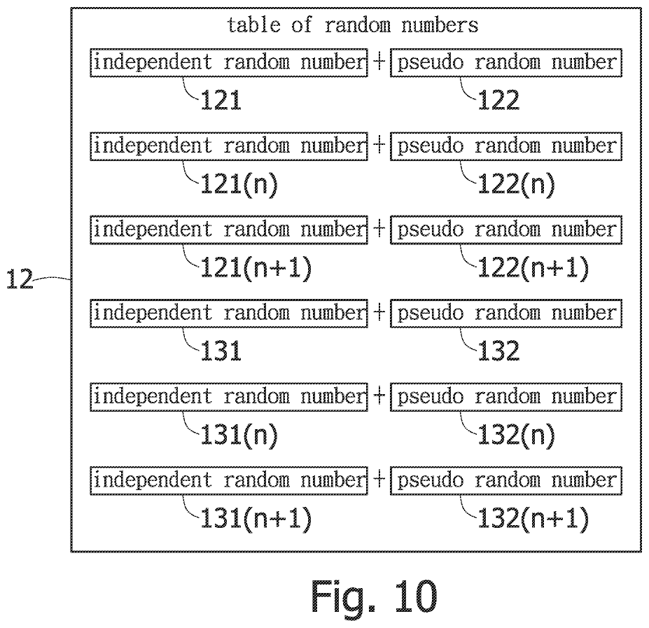

FIG. 10 is a schematic view of the table of random numbers 12 of FIGS. 1 and 2, wherein the table of random numbers 12 shows multiple different stages of updating the dynamic images 222, 232 in the mesh network 4, and the table of random numbers 12 includes multiple sets of independent random numbers 121, 131, multiple sets of independent random numbers 121(n), 131 (n), multiple sets of independent random numbers 121(n+1), 131 (n+1), multiple sets of pseudo random numbers 122, 132, multiple sets of pseudo random numbers 122(n), 132(n), and multiple sets of pseudo random numbers 122(n+1), 132(n+1), etc.

FIG. 11 is a schematic view of the table of random numbers 12 of FIGS. 8 and 9, wherein the table of random numbers 12 includes multiple sets of independent random numbers 121, 131, multiple sets of independent random numbers 121(n), 131 (n), multiple sets of independent random numbers 121(n+1), 131 (n+1), multiple sets of time axes 123, 133, multiple sets of time axes 123(n), 133(n), and multiple sets of time axes 123(n+1), 133(n+1), etc.

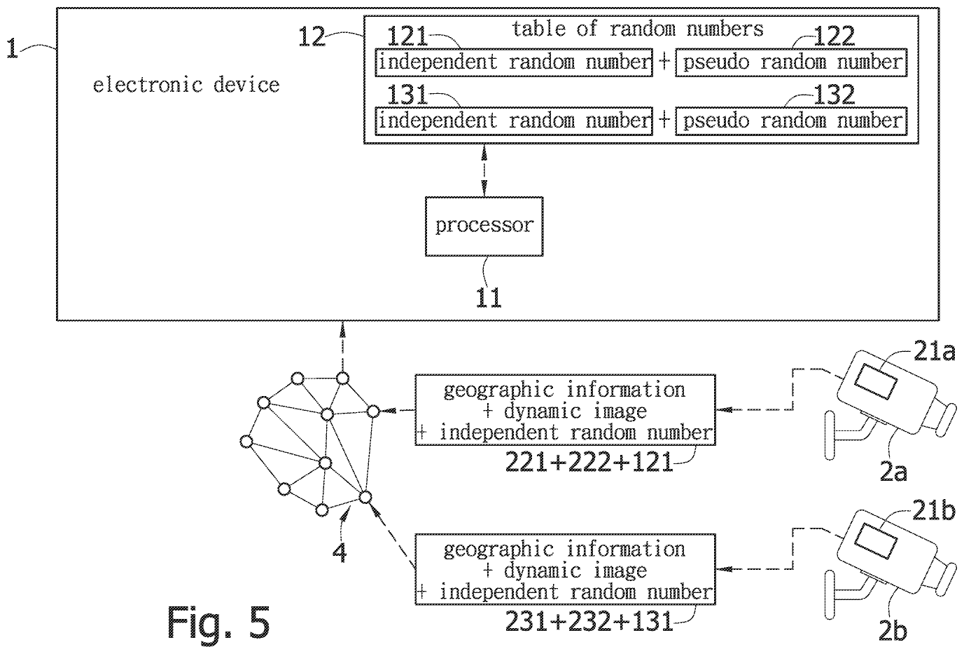

The processor 11 of the electronic device 1 updates the independent random numbers 121, 131 based on a change recorded by the record on spot devices 2a or 2b. For instance, when the record on spot devices 2a or 2b records a change, the multiple sets of independent random numbers 121, 131 and the multiple sets of pseudo random numbers 122, 132 (or the multiple sets of time axes 123, 133 of FIG. 11) are updated and shown in FIGS. 10 and 11 and are defined to the multiple sets of independent random numbers 121(n+1), 131(n+1), and the multiple sets of pseudo random numbers 122(n+1), 132(n+1) (or the multiple sets of time axes 123(n+1), 133(n+1) of FIG. 11) are updated. Referring to FIG. 5, after sending the updated dynamic images 222, 232, the communicators 21a, 21b of the record on spot devices 2a or 2b send updated data back to the electronic device 1 according to a path of a routing information base so that the electronic device 1 produces random number seeds in the table of random numbers 12 based on a uncertainty of uploading time, the record on spot devices 2a or 2b of the first layer child node of the electronic device 1 download the multiple sets of independent random numbers 121(n+1), 131(n+1), or the field service devices 3a or 3b of the second layer child node of the electronic device 1 reads the multiple sets of pseudo random numbers 122(n+1), 132(n+1) (or the multiple sets of time axes 123(n+1), 133(n+1) of FIG. 11). When desiring to make the table of random numbers 12 more random, a truly random event is collected, such as creating a random pool, and continuously collecting physical random information in the system, such as keyboards, mice, input and output devices, system time, program ID, interruption time and so on. When the table of random numbers 12 requests to update the multiple sets of independent random numbers 121, 131 to 121(n+1), 131(n+1), the multiple sets of pseudo random numbers 122, 132 to 122(n+1), 132(n+1) or the multiple sets of time axes 123, 133 to 123(n+1), 133(n+1), the processor 11 of the electronic device 1 acquires, calculates and sends updated information so as to comply true randomness of cryptography, thus avoiding repeated random sample. The multiple sets of independent random number 121 of the electronic device 1 are updated to “01010011” from “00110101”, and the multiple sets of independent random number 131 are updated to “10110010” from “01000110”.

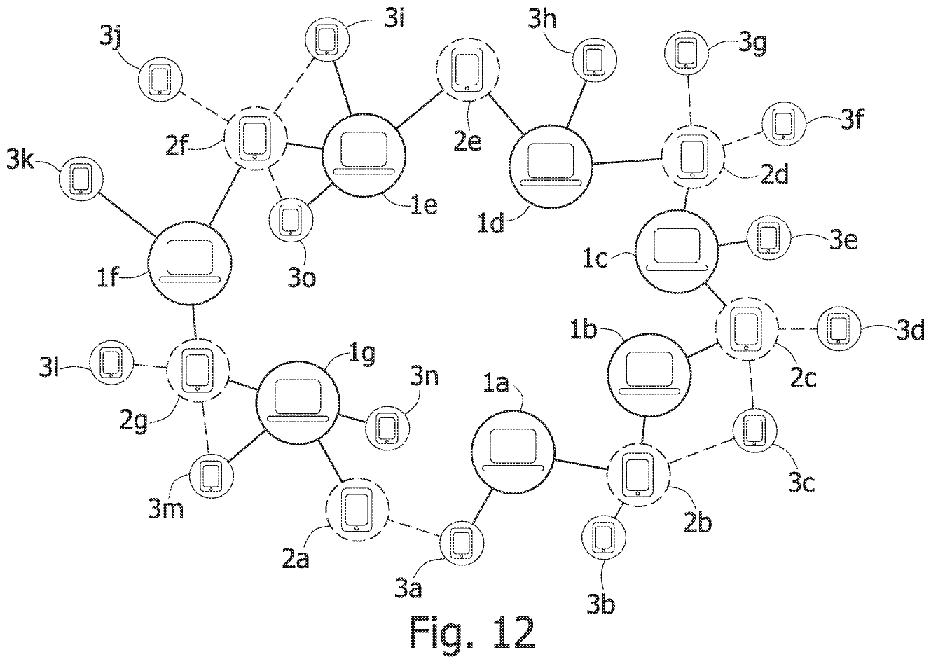

As shown in FIG. 12, the real food honesty display system is applicable for the block chain network 5, wherein the block chain network 5 includes multiple nodes communicating with one another, and each node is the electronic device 1, wherein the multiple nodes of the block chain network 5 are defined as source nodes of electronic devices 1a to 1g, record on spot devices 2a to 2g are defined as physical nodes, and field service devices 3a to 3g are defined as hypermedia nodes.

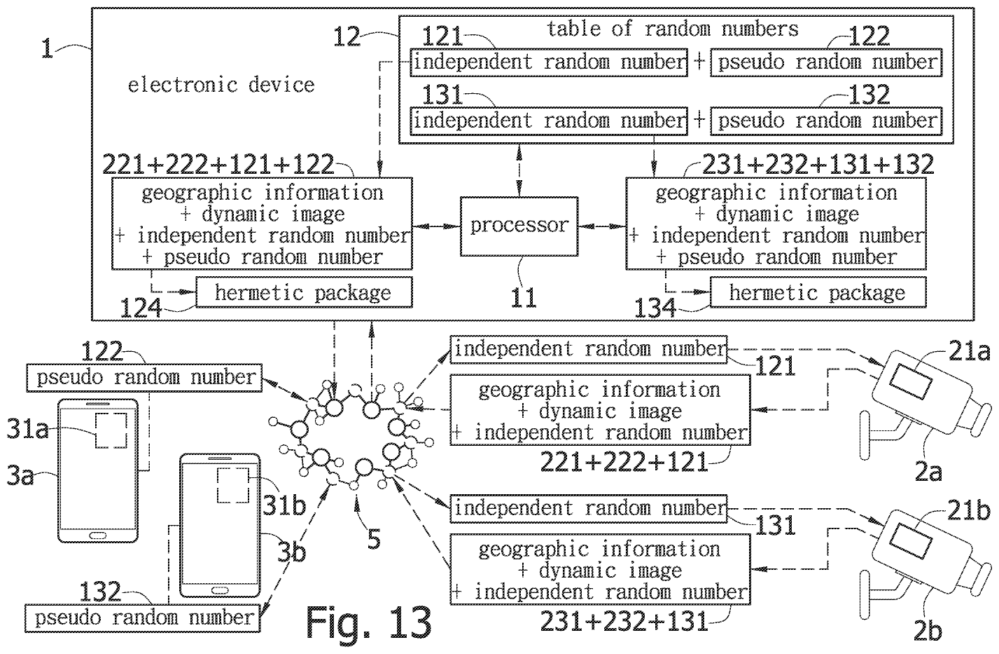

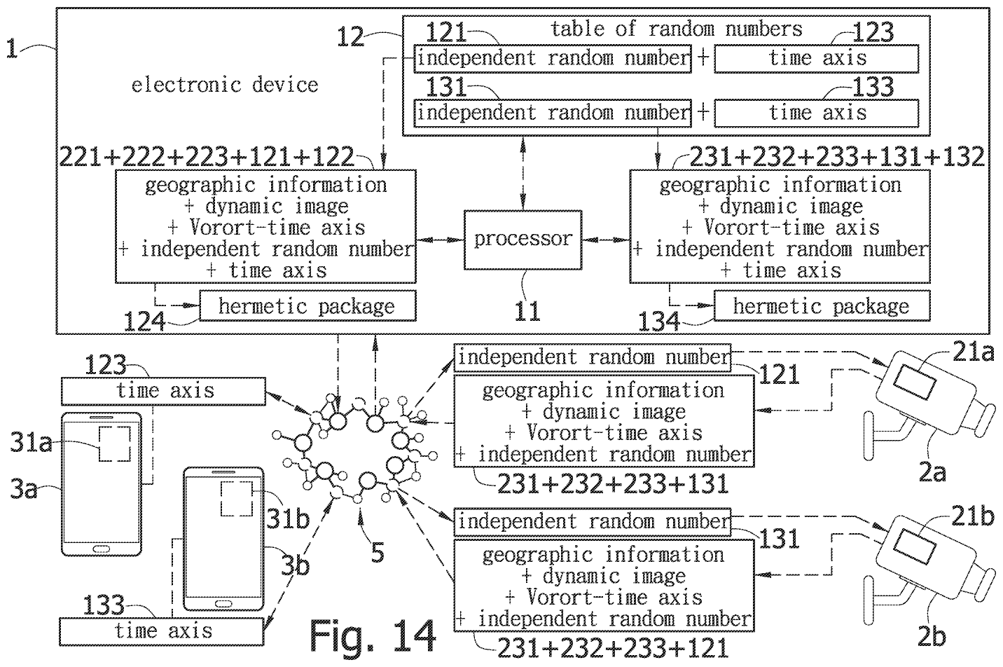

With reference to FIG. 13, the source nodes of the electronic device 1 are configured to construct the independent random numbers 121, 131 and the pseudo random numbers 122, 132 (or the time axes 123, 133, as shown in FIG. 14) and to receive or read the geographic informations 221, 231 and the dynamic images 222, 232 (or the geographic information 221, 231 and the spot time axis 223, 233 and the dynamic image 222, 232, as shown in FIG. 14), wherein the source nodes are the electronic device 1 having high computing capacity.

The two record on spot devices 2a, 2b are a smart phone or a tablet computer configured to shoot at least one video, at least one image, at least one continuous image, at least one digital image, or at least one photo, at least one picture, or at least one still picture. The geographic informations 221, 231 of a geographic information system are configured to position and represent GPS data of the GPS or global positioning data of a GPS, and the geographic informations 221, 231 of the geographic information system are used for positioning so as to verify the ecological structure cultivated by the fanner (planter) himself by way of the at least one image or the at least one picture shoot by the farmer (planter). Thereby, each consumer watches whether the farmer (planter) cultivates the ecological structure by using the natural agriculture, and the geographic informations 221, 231 and the dynamic images 222, 232 are uploaded to the block chain network 5 so that place of origin and manufacturing process of the product (such as food) are displayed by the dynamic images 222, 232, and the consumers learn these information. Preferably, the dynamic images 222, 232 present biological chains of the ecological structure (such as a farm), the positive emotion or the negative emotion of the affect reciprocity of the Animalia (such as the insects or the animals) so as to obtain friendly planting purpose and to enhance food safety and brand image.

A first farmer A uses a physical node of the record on spot device 2a as the source node to download the independent random number 121 at the first location, and the geographic information 221 and the dynamic image 222 are combined to the independent random number 121 (or the geographic information 221 and the spot time axis 223 and the dynamic image 222 are combined to the independent random number 121, as shown in FIG. 14), then the independent random number 121 are uploaded to the source nodes or the physical nodes. Furthermore, a first farmer B uses a physical node of the record on spot device 2b as the source node to download the independent random number 131 at the second location, and the geographic information 231 and the dynamic image 232 are combined to the independent random number 131 (or the geographic information 231 and the spot time axis 233 and the dynamic image 232 are combined to the independent random number 131, as shown in FIG. 14), then the independent random number 131 are uploaded to the source nodes or the physical nodes. The dynamic image 222 are updated and sent to the source nodes of the electronic device 1 so that the dynamic images 222, 223 update the nodes of the independent random numbers 121, 131 and the pseudo random numbers 122, 132 (or the time axes 123, 133).

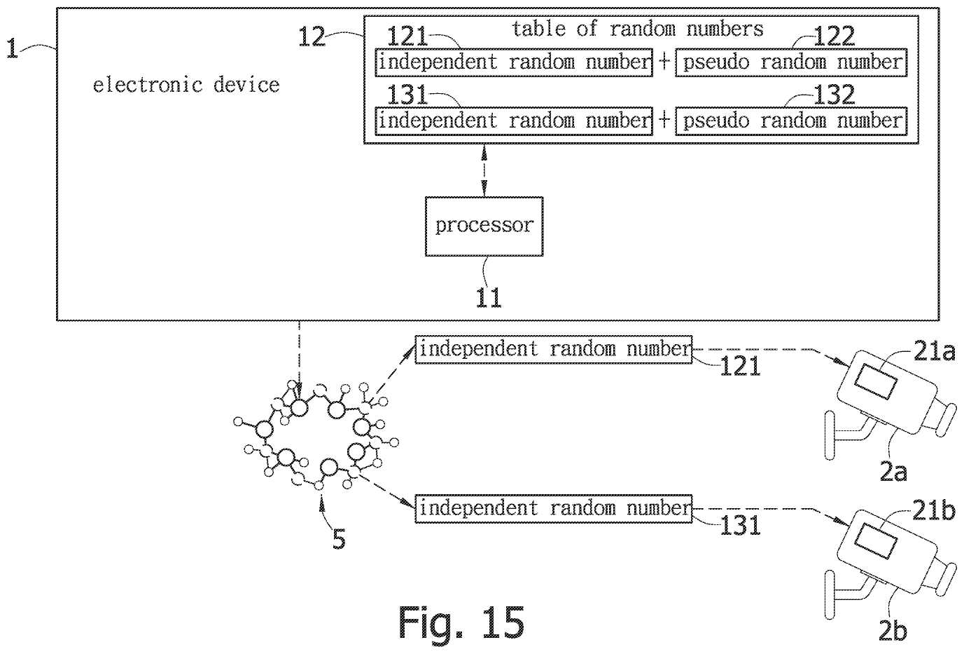

With reference to FIGS. 15 to 18, the source nodes of the electronic device 1 broadcast the independent random numbers 121, 131 to the block chain network 5 so that the physical nodes of the record on spot devices 2a, 2b of the block chain network 5 receive the independent random numbers 121, 131, wherein the independent random numbers 121, 131 includes a random number and a transmission data, the independent random numbers 121, 131 are at least five or an odd number above five or the independent random numbers 121, 131 are at least fourth or an even number above four. In this embodiment, the independent random numbers 121, 131 are at least five, and the transmitted data is binary code, such as 01001.

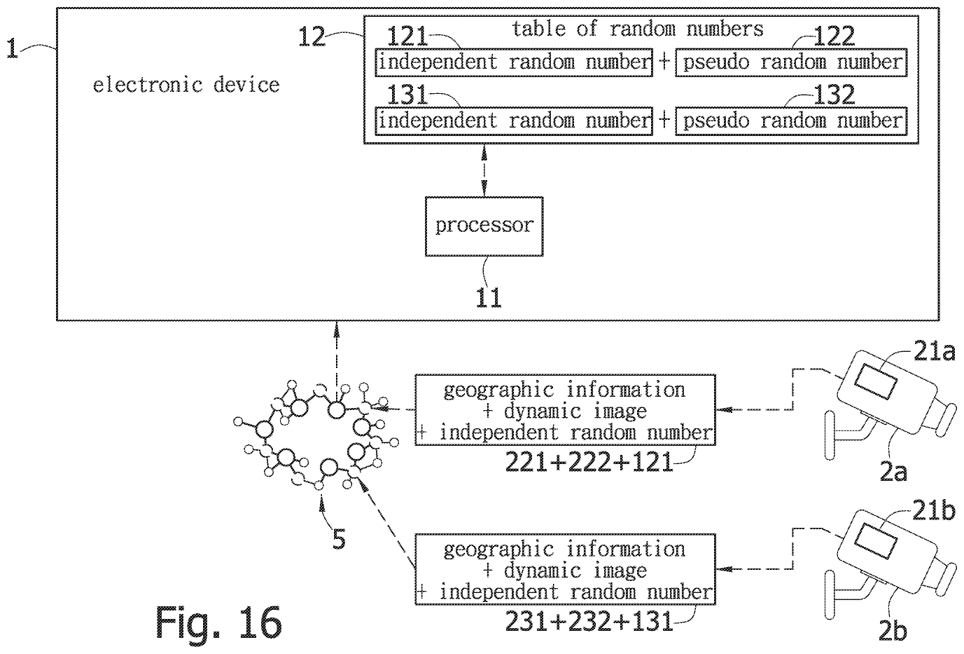

Referring to FIG. 16, the dynamic images 222, 232 of the physical nodes of the record on spot devices 2a, 2b broadcast to the block chain network 5, the other nodes of the block chain network 5 receive and send the dynamic images 222, 232 to one of the nodes of other electronic device 1, wherein when the source nodes of the electronic device 1 receive the change of the dynamic images 222, 232, the independent random numbers 121, 131 and the pseudo random numbers 122, 132 (or the time axes 123, 133) are updated once more.

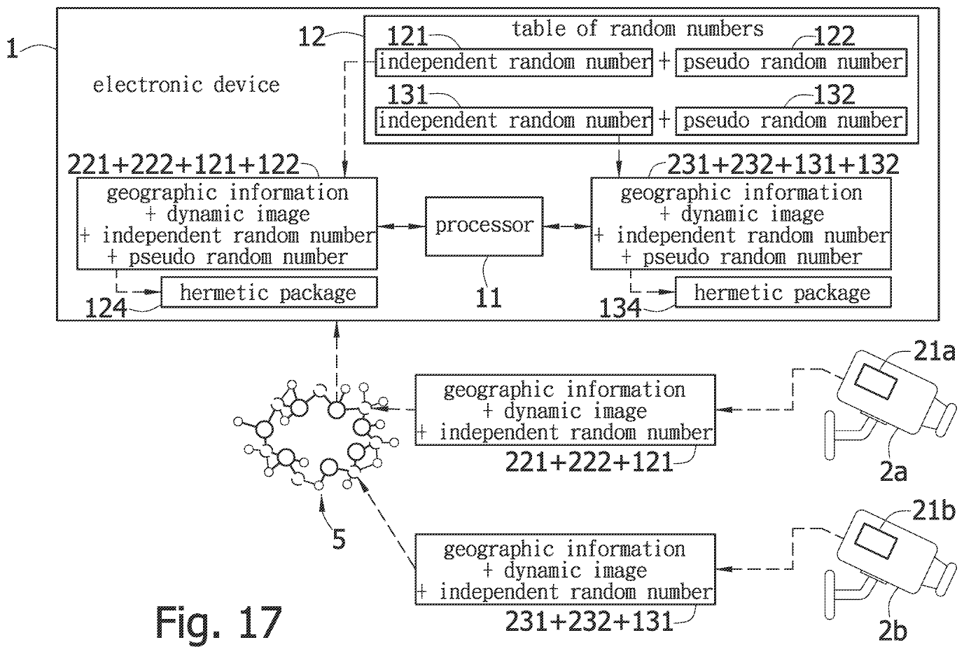

As illustrated in FIG. 17, hypermedia nodes of the field service devices 3a, 3b read the pseudo random numbers 122, 132 (or the time axes 123, 133) of the source nodes so that the pseudo random numbers 122, 132 (or the time axes 123, 133) and the independent random numbers 121, 131 combine to a random number, and the independent random numbers 121, 131, the pseudo random numbers 122, 132, the geographic informations 221, 231, and the dynamic images 222, 232 are transformed into hermetic packages 124, 134 by using an elastic function, then the hermetic packages 124, 134 are saved, wherein when the hermetic packages 124, 134 have a read access, the dynamic images 222, 232 of the source nodes are read, wherein the hypermedia node is a high computing node of the block chain network 5 designated based on an operation signal of a user.

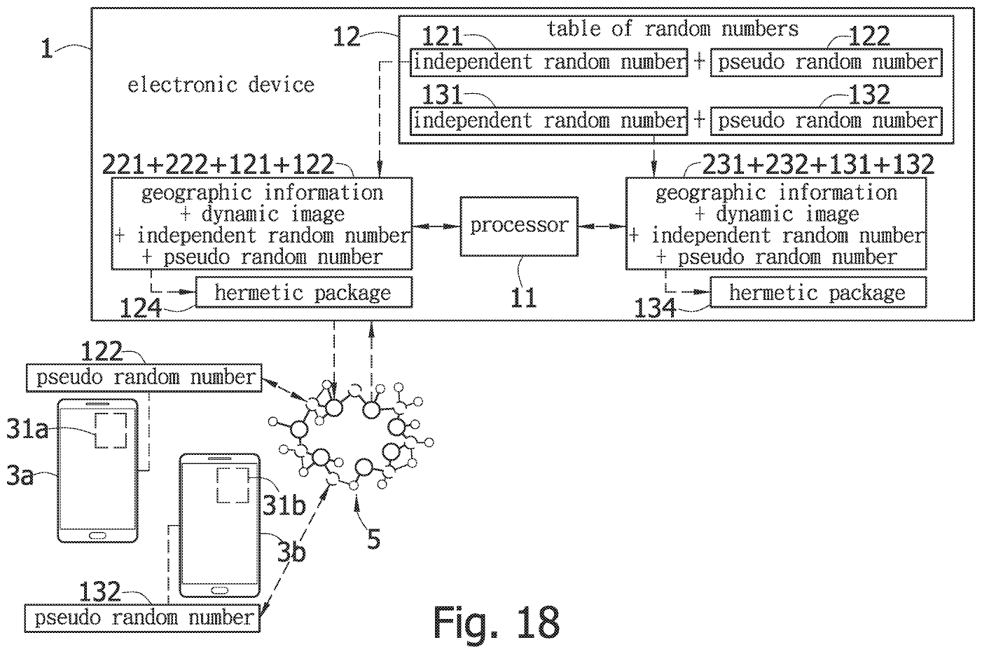

With reference to FIG. 18, the pseudo random numbers 122, 132 (or the time axes 123, 133) of the source nodes of the electronic device 1 are read by the hypermedia nodes of at least two field service devices 3a, 3b so that the hypermedia nodes of the at least two field service devices 3a, 3b are connected with the source nodes of the electronic device 1 by way of the pseudo random numbers 122, 132 (or the time axes 123, 133), and the source nodes of the electronic device 1 receive the pseudo random numbers 122, 132 (or the time axes 123, 133) again, wherein the pseudo random numbers 122, 132 (or the time axes 123, 133) and the independent random numbers 121, 131 are combined to the random number so as to read the dynamic images 222, 232 of the source nodes, such that a numerical response of the Animalia and an environmental health value and an affect reciprocity of the ecological structure of the record on spot devices 2a, 2b are captured from the dynamic images 222, 232, wherein the hypermedia nodes are a high computing node of the block chain network 5 designated based on an operation signal of a user from the source nodes of the electronic device 1 so as to be used as the hypermedia nodes of the field service devices 3a, 3b. Alternatively, all nodes of the block chain network 5 broadcast the dynamic images 222, 232 of the physical nodes of the record on spot devices 2a, 2b in priority.

After the physical nodes of the record on spot devices 2a, 2b send the dynamic images 222, 232 to the source nodes of the electronic device 1, the hypermedia nodes of the field service devices 3a, 3b receive updated quantity of the dynamic images 222, 232 from the source nodes of the electronic device 1 and the physical nodes of the record on spot devices 2a, 2b so that the electronic device 1 updates the independent random numbers 121, 131 and the pseudo random numbers 122, 132 (or the time axes 123, 133) according the change of the dynamic images 222, 232, a feedback signal is sent to the source nodes of the electronic device 1 from the nodes of the updated independent random numbers 121, 131.

When updating the independent random numbers 121, 131 and the pseudo random numbers 122, 132 (or the time axes 123, 133), the source nodes of the electronic device 1 notify the hypermedia nodes of the field service devices 3a, 3b to update so that the dynamic images 222, 232 updated by the source nodes become the hypermedia nodes and are read by the field service devices 3a, 3b.

When the dynamic images 222, 232 of the physical nodes of the record on spot devices 2a, 2b are sent to the block chain network 5 and the hypermedia node of the field service devices 3a, 3b read the pseudo random numbers 122, 132 (or the time axes 123, 133) to designate which one of the field service devices 3a, 3b is the hypermedia node, the hypermedia node is determined depending on many factors, for example, whether the electronic device 1 of the node is idle when receiving the dynamic images 222, 232 or whether a signal is sent smoothly from the source node of the electronic device 1 to another source node when broadcasting or whether the signal impacts with other signals. To improve a randomness of a hypermedia node selection of the field service devices 3a, 3b, and the independent random numbers 121, 131 and the pseudo random numbers 122, 132 (or the time axes 123, 133) limit the quantity of the physical nodes of the record on spot devices 2a, 2b and the quantity of the source nodes of the electronic device 1, the uncertainty of the quantity and the position of the hypermedia nodes is enhanced, such that it is difficult for attackers to position the hypermedia nodes of the field service devices 3a, 3b.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A real food honesty display system comprising:
an electronic device including a processor configured to construct an independent random number and a pseudo random number, and the independent random number and the pseudo random number being connected with a mesh network, wherein the independent random number and the pseudo random number are updated based on a change of dynamic image of a geographic information, the independent random number and the pseudo random number are combined to a random number, and the independent random number, the pseudo random number, the geographic information and the dynamic image are transformed into a hermetic package by using an elastic function, then the hermetic package is saved, wherein when the hermetic package has a read access, the electronic device acquires one of insect image features or animal image features of the dynamic image of the geographic information, such that at least one increasing or reducing numerical response of an insect image or an animal image is constructed based on the insect image features or the animal image features of the dynamic image so as to acquire one of audio characters of emotional expression from the dynamic image, and the audio characters are preset in multiple emotional dimension databases and correspond to an affect reciprocity of Animalia so as to confirm the one audio character of the multiple emotional dimension databases is a positive emotion or a negative emotion, such that an environmental health value is produced according to an increasing quantity, a shrinking quantity, or the affect reciprocity of the Animalia;
a record on spot device including a communicator connected with the mesh network so as to download the independent random number, wherein a field verification is executed by the record on spot device by using the geographic information, and a live transmission of a cultivation of an ecological structure of the dynamic image is executed, and the geographic information and the dynamic image are combined with the independent random number so as to upload the geographic information, the dynamic image, and the independent random number to the mesh network; and
a field service device configured to read the pseudo random number, and the field service device including a communication module built therein and connected with the hermetic package of the electronic device of the mesh network so that the independent random number and the pseudo random number are combined to the set close to the random number, such that the geographic information and the dynamic image of the hermetic package are read, and a numerical response is captured from the dynamic image of the geographic information of the record on spot device so as to reflect the numerical response becomes better or worse with the time, wherein the dynamic image are the insect image or the animal image, alternatively, the affect reciprocity of the Animalia is captured from the dynamic image of the record on spot device so as to determine the positive emotions or the negative emotions increase or decrease, thus distinguishing product quality in the ecological structure, wherein the affect reciprocity is the positive emotion or the negative emotion.
